(19) United States
(12) Patent Application Publication
(10) Pub. No.: US 2019/0038490 A1
(43) Pub. Date: Feb. 7, 2019

(54) Rotational Transfer Platform System

(71) Applicant: Torrance D. Lillevold, Bemidji, MN (US)

(72) Inventor: Torrance D. Lillevold, Bemidji, MN (US)

(21) Appl. No.: 16/153,879

(22) Filed: Oct. 8, 2018

Related U.S. Application Data
(63) Continuation-in-part of application No. 15/620,525, filed on Jun. 12, 2017, now Pat. No. 10,092,469.

(51) Int. Cl. A61G 7/053; A61G 7/10; A47B 91/00

(52) U.S. Cl. CPC A61G 7/053; A61G 7/1074; A61G 7/0528; A47B 91/005; A61G 7/1076; A61G 7/1046

(57) ABSTRACT

A rotational transfer platform system which aids in transferring an immobile individual from one location to another. The rotational transfer platform system generally includes a platform which is rotatably connected to a base which is adapted to rest on the ground. A walker frame extends from the upper surface of the platform to aid in securing any individual standing on the platform. The walker frame may be adapted to transition between an expanded state for use and a collapsed state for transport or storage. A locking member may be utilized to selectively lock rotation of the platform with respect to the base in one of a plurality of different radial positions to ease with transferring an individual from one location to another.

### CROSS REFERENCE TO RELATED APPLICATIONS

I hereby claim benefit under Title 35, United States Code, Section 120 of U.S. patent application Ser. No. 15/620,525 filed Jun. 12, 2017. This application is a continuation-in-part of the Ser. No. 15/620,525 application. The Ser. No. 15/620,525 application is currently pending. The Ser. No. 15/620,525 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to a rotational transfer platform system which aids in transferring an immobile individual from one location to another.

### Related Art

Any discussion of the related art throughout the specification should in no way be considered as an admission that such related art is widely known or forms part of common general knowledge in the field.

The transport of immobile patients from one location to another is common in a wide range of areas, including in hospitals and nursing homes. It is important that such immobile patients be transported in a manner which is not only safe for the patients themselves, but also for any caretakers aiding in such transport. A common example would be the transport of an immobile patient from a wheelchair onto a bed.

In the past, such immobile patients have been moved in manners which heavily rely upon caretakers in aiding to move the patient. For example, a pair of caretakers may hold onto the patient and aid the patient in moving locations. This opens up the risk of injury both to the patient and to the caretakers. It would be far preferable to have a system to safely transport the patient that minimizes risk of injury to the patient or the caretakers during transport.

### SUMMARY

An example embodiment is directed to a rotational transfer platform system. The rotational transfer platform system includes a platform comprising an upper surface and a lower surface. A walker frame may be connected to the upper surface of the platform, wherein the walker frame comprises a first frontal support, a second frontal support, a first rear support, and a second rear support, wherein the walker frame is adapted to be at least partially collapsed onto the upper surface of the platform. A base may be adapted to contact a ground surface, wherein the platform is selectively rotatable with respect to the base. A braking mechanism may be provided for selectively inhibiting rotation of the platform so as to lock the platform into one of a plurality of rotational positions with respect to the base.

There has thus been outlined, rather broadly, some of the embodiments of the rotational transfer platform system in order that the detailed description thereof may be better understood, and in order that the present contribution to the art may be better appreciated. There are additional embodiments of the rotational transfer platform system that will be described hereinafter and that will form the subject matter of the claims appended hereto. In this respect, before explaining at least one embodiment of the rotational transfer platform system in detail, it is to be understood that the rotational transfer platform system is not limited in its application to the details of construction or to the arrangements of the components set forth in the following description or illustrated in the drawings. The rotational transfer platform system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a rotational transfer platform system being used to aid a patient from a wheelchair in accordance with an example embodiment.

FIG. 2 is a perspective view of a rotational transfer platform system being used to aid a patient onto a bed in accordance with an example embodiment.

FIG. 3 is an upper perspective view of a rotational transfer platform system in an expanded state in accordance with an example embodiment.

FIG. 4 is an upper perspective view of a rotational transfer platform system in a collapsed state in accordance with an example embodiment.

FIG. 5 is an upper perspective view of a rotational transfer platform system being transported in a collapsed state in accordance with an example embodiment.

FIG. 6 is a top view of a rotational transfer platform system in accordance with an example embodiment.

FIG. 7 is a bottom view of a rotational transfer platform system in accordance with an example embodiment.

FIG. 8a is a top sectional view of a rotational transfer platform system illustrating rotation of the platform in accordance with an example embodiment.

FIG. 8b is a top view of a locking member of a rotational transfer platform system illustrating the locking and unlocking of the locking member in accordance with an example embodiment.

FIG. 9a is a side view of a rotational transfer platform system in an expanded and locked state in accordance with an example embodiment.

FIG. 9b is a side view of a locking member of a rotational transfer platform system in an unlocked state in accordance with an example embodiment.

FIG. 9c is a side view of a locking member of a rotational transfer platform system in a locked state in accordance with an example embodiment.

FIG. 10 is a perspective view of a rotational transfer platform system being used to aid a patient from a wheelchair in accordance with an example alternate embodiment.

FIG. 11 is a perspective view of a rotational transfer platform system being used to aid a patient onto a bed in accordance with an example alternate embodiment.

FIG. 12 is a perspective view of a rotational transfer platform system in an expanded state in accordance with an example alternate embodiment.

FIG. 13 is a perspective view of a rotational transfer platform system in a collapsed state in accordance with an example alternate embodiment.

FIG. 14 is a perspective view illustrating lifting a rotational transfer platform system to be transported by rolling in accordance with an example alternate embodiment.

FIG. 15 is a top view of a rotational transfer platform system in accordance with an example alternate embodiment.

FIG. 16 is a bottom view of a rotational transfer platform system in accordance with an example alternate embodiment.

FIG. 17 is a top view of a rotational transfer platform system in a first rotational position in accordance with an example alternate embodiment.

FIG. 18 is a top view of a rotational transfer platform system in a second rotational position in accordance with an example alternate embodiment.

FIG. 19A is an upper perspective view of a platform of a rotational transfer platform system in accordance with an example alternate embodiment.

FIG. 19B is an upper perspective view of a tension knob of a rotational transfer platform system in accordance with an example alternate embodiment.

FIG. 20A is a rear end view of a rotational transfer platform system in accordance with an example alternate embodiment.

FIG. 20B is a perspective view of a tension knob in a first position to set a first level of tension of a rotational transfer platform system in accordance with an example alternate embodiment.

FIG. 20C is a perspective view of a tension knob in a second position to get a second level of tension of a rotational transfer platform system in accordance with an example alternate embodiment.

FIG. 21 is a bottom view of a rotational transfer platform system in accordance with an example alternate embodiment.

FIG. 22 is a side view of a rotational member and braking mechanism of a rotational transfer platform system in accordance with an example alternate embodiment.

FIG. 23 is a top view of a rotational member and braking mechanism of a rotational transfer platform system in accordance with an example alternate embodiment.

FIG. 24 is a perspective view of a rotational member and braking mechanism of a rotational transfer platform system in accordance with an example alternate embodiment.

FIG. 25 is an upper perspective view of a rotational transfer platform system in an expanded state in accordance with an example alternate embodiment.

FIG. 26 is an upper perspective view of a rotational transfer platform system in a partially collapsed state in accordance with an example alternate embodiment.

FIG. 27 is an upper perspective view of a rotational transfer platform system in a partially collapsed state in accordance with an example alternate embodiment.

FIG. 28 is an upper perspective view of a rotational transfer platform system in a partially collapsed state in accordance with an example alternate embodiment.

FIG. 29 is a perspective exploded view of a platform of a rotational transfer platform system in accordance with an example alternate embodiment.

### DETAILED DESCRIPTION

### A. Overview

An example rotational transfer platform system generally comprises a platform 20 which is rotatably connected to a base 50 which is adapted to rest on the ground. A walker frame 30 extends from the upper surface 23 of the platform 20 to aid in securing any individual standing on the platform 20. The walker frame 30 may be adapted to transition between an expanded state for use and a collapsed state for transport or storage. A locking member 27 may be utilized to selectively lock rotation of the platform 20 with respect to the base 50 in one of a plurality of different radial positions to ease with transferring an individual from one location to another.

The rotational transfer platform system may comprise a platform 20 comprising an upper surface 23 and a lower surface 24. A walker frame 30 is connected to the upper surface 23 of the platform 20, with the walker frame 30 being adapted to be at least partially collapsed onto the upper surface 23 of the platform 20. A base 50 adapted to contact a ground surface is provided; with the lower surface 22 of the platform 20 being rotatably connected to the base 50 by a bearing 55.

The walker frame 30 may be adjustable between a first position in which the walker frame 30 is upright on the upper surface 23 of the platform 20 and a second position in which the walker frame 30 is collapsed onto the upper surface of the platform 20. The walker frame may comprise one or more frontal supports 31, 35 and one or more rear supports 40, 43; with the rear supports 40, 43 being hingedly connected to the platform 20 and the frontal supports 31, 35 being removably connected to the platform 20. The frontal supports 31, 35 may define a gap to provide access on to or off of the platform 20. One or more cross supports 46 may extend between the rear supports 40, 43; with a first rear support 40 being hingedly connected to a first end of the cross support 46 and a second rear support 43 being hingedly connected to a second end of the cross support 46. The walker frame 30 is adapted to be collapsed by disconnected the frontal supports 31, 35 from the platform 20 and rotating the frontal supports 31, 35 to rest on the platform 20.

One or more anchors 25 may be on the upper surface 23 of the platform 20; with the frontal supports 31, 35 being connected to the anchors 25 and the rear supports 40, 43 being disconnected from the anchors 25 when the walker frame 30 is in the first, expanded position. The rear supports 40, 43 are connected to the anchors 25 and the frontal supports 31, 35 are disconnected from the anchors 25 when the walker frame 30 is in the second, collapsed position; with the anchors 25 securing the collapsed supports 31, 35, 40, 43 against the upper surface 23 of the platform 20. In the exemplary embodiment of the figures, a first anchor 25 and a second anchor 25 are shown on the upper surface 23 of the platform 20; with the first frontal support 31 being connected to the first anchor 25 and the second frontal support 35 being connected to the second anchor 25 when the walker frame 30 is in the first position and the first rear support 40 being connected to the first anchor 25 and the second rear support 43 being connected to the second anchor 25 when the walker frame 30 is in the second, collapsed position.

A locking member 27 such as a pin or the like may be provided for locking the platform 23 into one of a plurality of rotational positions with respect to the base 50. The base 50 may include a plurality of lock receivers 54 such as openings which are each adapted to selectively engage with the locking member 27 to lock the platform 20 into one of the plurality of rotational positions with respect to the base.

One or more wheels 58 may extend from the base 50 in a direction parallel with an axis extending across the upper surface 23 of the platform 20 (in a horizontal direction when the platform 20 is resting on a ground surface). The wheels 58 will only engage with the ground surface when the platform 20 is tiled diagonally to aid in transport.

### B. Platform

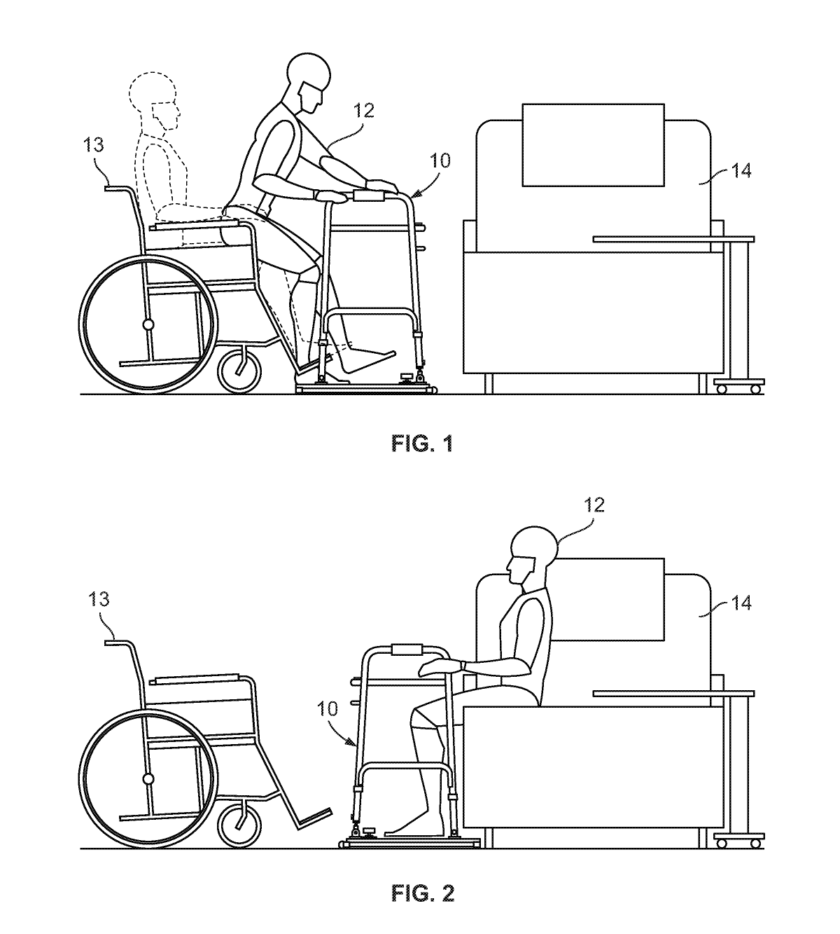

As best shown in FIGS. 1-4, a platform 20 is utilized on which a patient 12 may stand when the present invention is in use. The platform 20 is adapted to be rotated with respect to the base 50 to maneuver a patient 12 between various locations; such as between a wheelchair 13 and a bed 14. The shape, size, and configuration of the platform 20 may vary in different embodiments and thus should not be construed as limited by the exemplary figures.

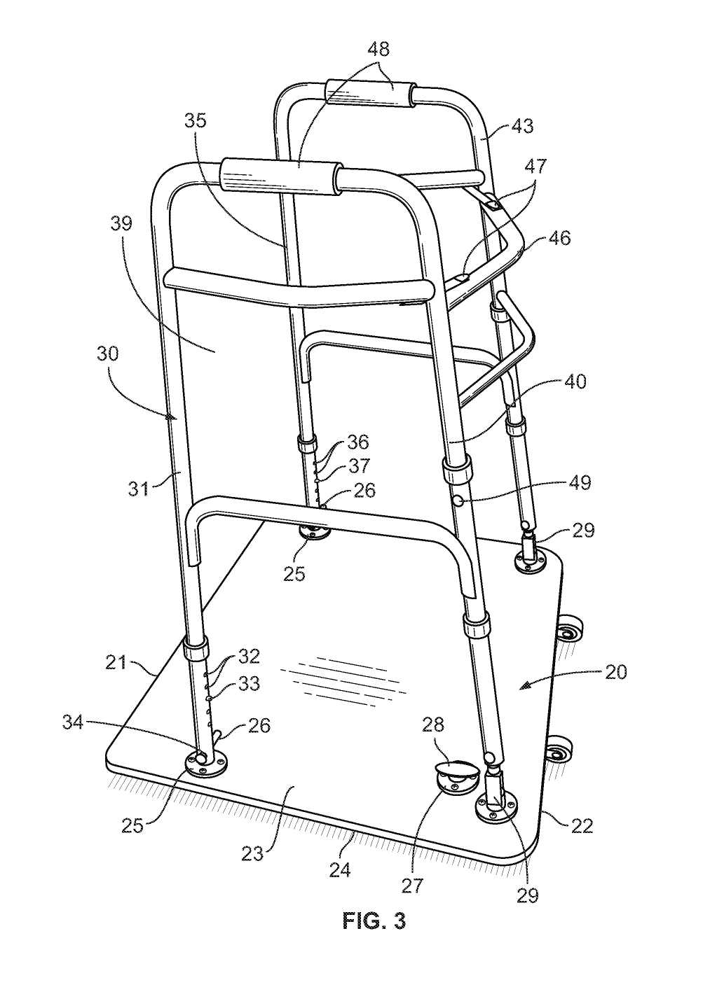

The platform 20 is shown in FIG. 3 as comprising a rectangular structure having a front end 21, a rear end 22, an upper surface 23, and a lower surface 24. The front end 21 of the platform 20 is generally utilized by the patient 12 to get on or get off the platform 20. The rear end 22 of the platform 20 may include wheels 58 as described herein to aid in transporting the platform 20 when in its collapsed state.

The upper surface 23 of the platform 20 includes a collapsible walker frame 30. The walker frame 30 in some embodiments may be completely removable from the platform 20. In other embodiments, the walker frame 30 may be partially removable from the platform 20 to allow the walker frame 30 to be collapsed onto the platform 20 for transport.

The upper surface 23 of the platform 20 may include anchors 25 to which one or more of the supports 31, 35, 40, 43 may be fixedly or removably connected. Each of the anchors 25 may include an opening extending therethrough to selectively receive an anchor pin 26 for connecting the support 31, 35, 40, 43 to the anchor 25. In the embodiment shown in FIG. 3, the first frontal support 31 is connected to a first anchor 25 by a first anchor pin 26 and the second frontal support 35 is connected to a second anchor 25 by a second anchor pin 26. Various other configurations may be utilized in different embodiments.

The upper surface 23 of the platform 20 may also include hinges 29 to which one or more supports 31, 35, 40, 43 of the walker frame 30 are hingedly connected. The hinges 29 may be fixedly or removably connected to the platform 20. In the exemplary figures, the rear supports 40, 43 of the walker frame 30 are illustrated as being connected to the platform 20 via hinges 29 near the rear end 22 of the platform 20.

The lower surface 24 of the platform 20 is connected to the base 50 via a bearing 55. In the embodiment shown in the figures, the bearing 55 is connected between the lower surface 24 of the platform 20 and the base 50 such that the platform 20 may freely rotate with respect to the base 50 if not locked.

The platform 20 may also include a locking member 27 as best shown in FIGS. 9A, 9B, and 9C. The locking member 27 may extend through the platform 20 from its upper surface 23 to its lower surface 24. The locking member 27 is preferably adapted to extend downwardly to selectively engage with a corresponding lock receiver 54 on the base 50 to selectively prevent rotation of the platform 20 with respect to the base 50 as discussed herein.

Various types of locking members 27 may be utilized, such as pins, clamps, or the like. In the exemplary figures, the locking members 27 are configured to extend downwardly and engage with the base 50 to lock the platform 20 and retract upwardly and disengage from the base 50 to unlock the platform 20. The locking member 27 may include a locking handle 28 which may be rotated, pushed, pulled, or otherwise adjusted to engage or disengage the locking member 27.

### C. Walker Frame

As shown throughout the figures, a walker frame 30 is positioned on the upper surface 23 of the platform 20. The walker frame 30 aids a patient 12 in getting on and getting off the platform 20; as well as providing stability while on the platform 20 itself, such as while the platform 20 is being rotated. The walker frame 30 is preferably adapted to be collapsed onto the upper surface 23 of the platform 20 when not in use to ease storage and transport of the present invention.

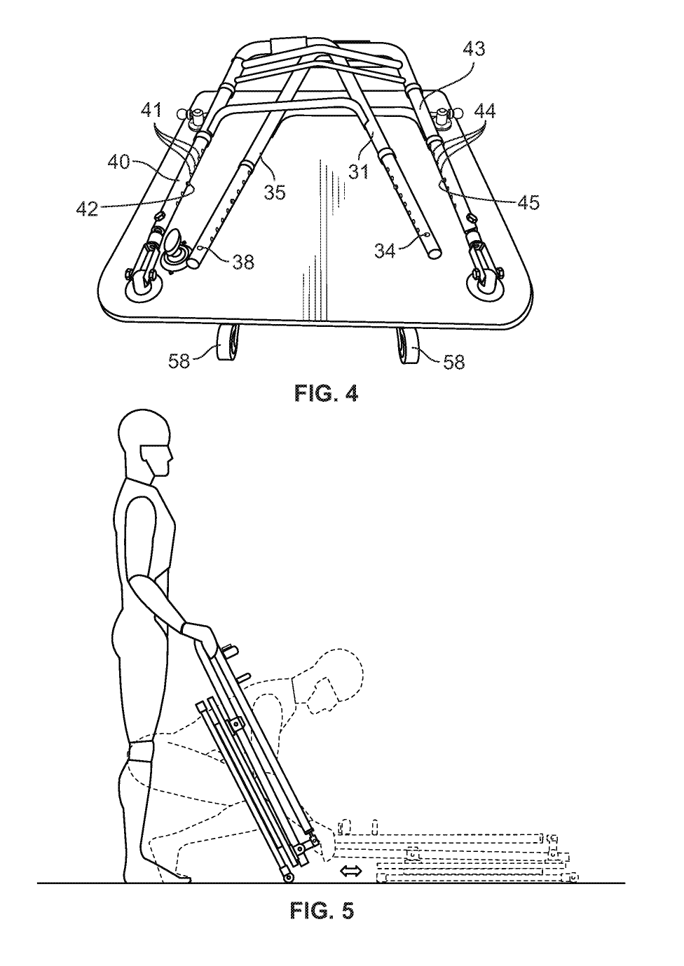

As shown in FIGS. 3 and 4, the walker frame 30 is adapted to transition between a first, expanded state in which the walker frame 30 may be relied upon for support by a patient 20 and a second, collapsed state in which at least a portion of the walker frame 30 is collapsed onto the upper surface 23 of the platform 20 such that the present invention is more compact for transport and storage. The walker frame 30 may be fully or partially collapsible in different embodiments. The manner in which the walker frame 30 is collapsed, and the portions of the walker frame 30 which are collapsible, may vary in different embodiments.

The shape, size, and structure of the walker frame 30 may vary in different embodiments and should not be construed as limited by the figures. As shown in FIG. 3, the walker frame 30 may comprise a first frontal support 31 and a second frontal support 35 which are positioned near the front end 21 of the platform 20. The walker frame 30 may also comprise a first rear support 40 and a second rear support 43 which are positioned near the rear end 22 of the platform 20. Each of the supports 31, 35, 40, 43 will generally comprise rods, bars, or other elongated structures which may serve as supports on which the patient 12 may lean or which the patient 12 may grasp for stability when getting on, getting off, or standing on the platform 20.

As shown in the figures, the walker frame 30 may include a first frontal support 31 and a second frontal support 35 at or near the front end 21 of the platform 20 on its upper surface 23. The frontal supports 31, 35 may be fixedly or removably connected to the platform 20. A gap 39 between the frontal supports 31, 35 allows access to step up onto or step down off of the upper surface 23 of the platform 20 by a patient 12.

The frontal supports 31, 35 may be height-adjustable in some embodiments. The frontal supports 31, 35 may be telescopically-adjustable as shown in the figures or may otherwise be adjusted in height. This allows for the frontal supports 31, 35 to be adjusted to suit different types of patients 12.

The first frontal support 31 may thus include a plurality of first adjustment openings 31 extending along at least a portion of its length and the second frontal support 35 may include a plurality of second adjustment openings 36 extending along at least a portion of its length. A first adjustment pin 33 may be removably and selectively inserted within one of the first adjustment openings 32 and the second adjustment pin 37 may be removably and selectively inserted within one of the second adjustment openings 36 to lock the first and second frontal supports 31, 35 at a specific height to telescopically adjust the frontal supports 31, 35.

Each of the frontal supports 31, 35 are preferably removably connected to the platform 20. The frontal supports 31, 35 may be disconnected from the platform 20 to collapse the walker frame 30 into its collapsed state such as shown in FIGS. 4 and 5.

Each of the frontal supports 31, 35 is preferably removably connected to the platform 20 via use of anchors 25 on the upper surface 23 of the platform 20. The first frontal support 31 may include a first anchor opening 34 which is aligned with an anchor 25 such that an anchor pin 26 may be removably inserted within the first anchor opening 34 to removably connect the first frontal support 31 to the platform 20. The second frontal support 35 may similarly include a second anchor opening 38 which is aligned with an anchor 25 such that an anchor pin 26 may be removably inserted within the second anchor opening 38 to removably connect the second frontal support 35 to the platform 20.

As shown in the figures, the walker frame 30 may include a first rear support 40 and a second rear support 43 at or near the rear end 22 of the platform 20 on its upper surface 23. The rear supports 40, 43 may be fixedly or removably connected to the platform 20. In a preferred embodiment as shown in the figures, the rear supports 40, 43 are hingedly connected to the platform 20 such that the rear supports 40, 43 may be rotated downwardly to rest on the platform 20 when the walker frame 30 is in its collapsed state.

The rear supports 40, 43 may be height-adjustable in some embodiments. The rear supports 40, 43 may be telescopically-adjustable as shown in the figures or may otherwise be adjusted in height. This allows for the height of the rear supports 40, 43 to be adjusted to suit different types of patients 12.

The first rear support 40 may thus include a plurality of third adjustment openings 41 extending along at least a portion of its length and the second rear support 43 may include a plurality of fourth adjustment openings 44 extending along at least a portion of its length. A third adjustment pin 42 may be removably and selectively inserted within one of the third adjustment openings 41 and the fourth adjustment pin 45 may be removably and selectively inserted within one of the fourth adjustment openings 44 to lock the first and second rear supports 40, 43 at a specific height to telescopically adjust the rear supports 40, 43.

As best shown in FIG. 3, one or more cross supports 46 may extend between the first and second rear supports 40, 43. The frontal supports 31, 35 do not include cross supports 46 to allow for the gap 39 through which a patient 12 may pass to get on or get off the walker frame 30. The cross supports 46 may be hingedly connected to the rear supports 40, 43 by one or more support hinges 47. This allows for the rear supports 40, 43 to rotate inwardly with respect to the cross supports 46 to collapse the walker frame 30 into its collapsed state such as shown in FIGS. 4 and 5.

The rear supports 40, 43 are preferably hingedly connected to the platform 20 so that the rear supports 40, 43 may be hingedly rotated downwardly toward the platform 20 when collapsing the walker frame 30 or hingedly rotated upwardly away from the platform 20 when expanding the walker frame 30. Thus, each of the rear supports 40, 43 may be connected at their lower ends to the platform 20 by hinges 29 which are positioned on the upper surface 21 of the platform 20.

The rear supports 40, 43 may also each include a rear anchor opening 49 along their lengths. When the rear supports 40, 43 are collapsed onto the platform 20, the rear supports 40, 43 may be removably connected to the anchors 25 via the same anchor pins 26 such as shown in FIG. 4 which connect the frontal supports 31, 35 to the platform 20 when the walker frame 30 is in its expanded state.

A pair of handles 48 may extend from the rear supports 40, 43 to the frontal supports 21, 25. In the exemplary figures, a first handle 48 extends between the first frontal support 21 and the first rear support 40 and a second handle 48 extends between the second frontal support 25 and the second rear support 43. The handles 48 may be grasped by a patient 12 when on the platform 20.

### D. Base

As shown throughout the figures, the platform 20 is rotatably connected to a base 50 such that the platform 20 may rotate with respect to the base 50. The base 50 is adapted to rest on the floor; with the platform 20 not directly contacting the floor. The height at which the platform 20 is positioned above the floor by the base 50 may vary in different embodiments.

The base 50 may comprise various configurations, such as the use of a frame of cross members 51, 52 as shown in the figures; with a first cross member 51 extending diagonally across the lower surface 24 of the platform 20 in a first direction and a second cross member 52 extending diagonally across the lower surface 24 of the platform 20 to form an “X-shaped” configuration. The distal ends of the cross members 51, 52 may include feet 53 which are adapted to engage with and frictionally secure the base 50 against the floor.

The base 50 may include a plurality of lock receivers 54 with which the locking member 27 may removably engage to lock the platform 20 from rotation with respect to the base 50 in a plurality of positions. In the exemplary figures, there are four lock receivers 54 which are each separated by approximately ninety degree increments of rotation.

In this manner, the platform 20 may be locked from rotation in one of four different rotational positions with respect to the base 50. The lock receivers 54 may comprise openings on the base 50, such as within the cross members 51, 52, which are adapted to removably receive and retain the locking member 27 to prevent rotation of the platform 20 with respect to the base 50.

As shown in the figures, a bearing 55 is connected between the platform 20 and the base 50 such that the base 50 and platform 20 are not directly in contact. The bearing 55 allows the platform 20 to freely rotate with respect to the base 50 when the locking member 27 is not engaged within any of the lock receivers 54 of the base 50. Various types of bearings 55 may be utilized and thus the structure, configuration, shape, and size of the exemplary bearing 55 shown in the figures should not be construed as limiting on the scope of the present invention.

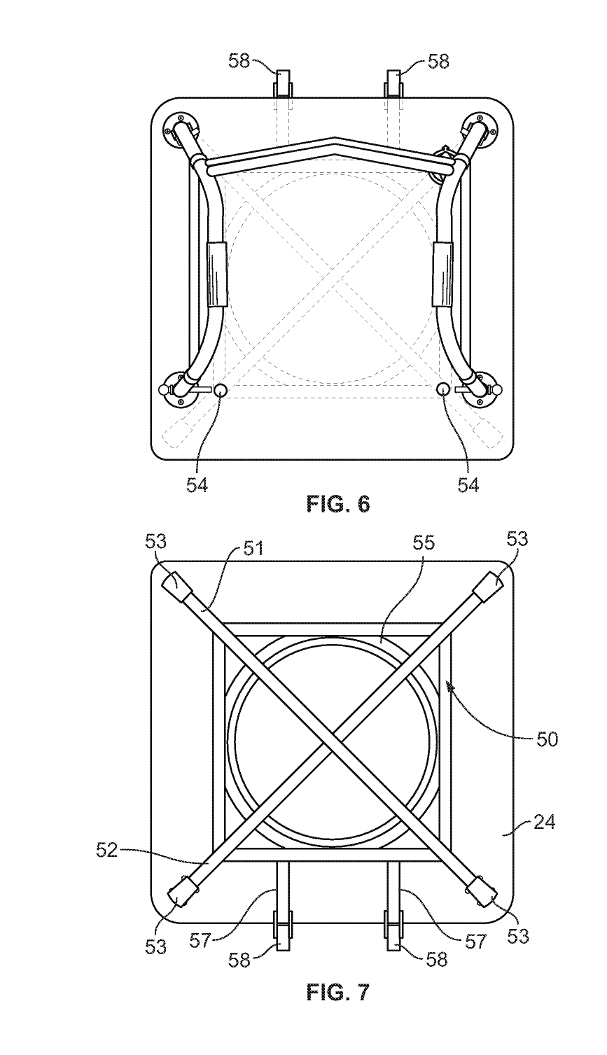

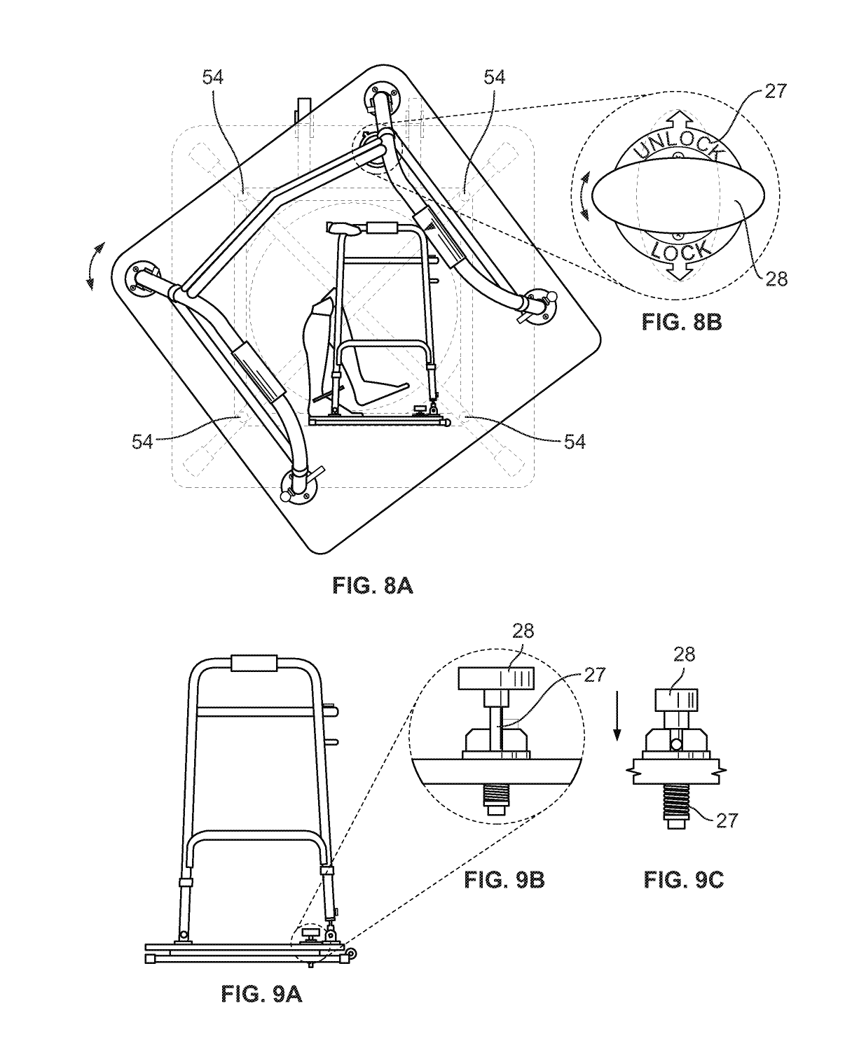

As best shown in FIGS. 4-8, one or more wheels 58 may extend horizontally outward from underneath the base 50. In the exemplary embodiment of FIGS. 6 and 7, a pair of horizontally-oriented wheel supports 57 extend outwardly along parallel with the axis extending across the upper surface 23 of the platform 20. Each of the wheels supports 57 includes a wheel 58 at its distal end. The wheels 58 extend outwardly from underneath the platform 20 such that the wheels 58 do not contact the ground underneath the platform 20 when the platform 20 is lying flat. The wheels 58 only engage with the ground when the platform 20 is tilted such as shown in FIG. 5 to ease transport of the present invention.

### E. Operation of Preferred Embodiment

In use, the walker frame 30 should first be expanded for use before having a patient utilize the present invention. The anchor pins 26 are first disengaged from the anchors 25 to disconnect the rear supports 40, 43 from the platform 20. The rear supports 40, 43 may then be rotated into an upright orientation by use of the hinges 29 and then rotated outwardly away from the cross supports 46 by use of the support hinges 47.

The frontal supports 31, 35 may then be connected to the same anchors 25 via the same anchor pins 26 to connect the frontal supports 31, 35 to the platform 20 and form the complete walker frame 30. The height of the frontal supports 31, 35 may be adjusted using the first and second adjustment openings 32, 36 and first and second adjustment pins 33, 37. Similarly, the height of the rear supports 40, 43 may be adjusted using the third and fourth adjustment openings 41, 44 and third and fourth adjustment pins 42, 45.

With the walker frame 30 in its expanded state, a patient 12 may utilize the present invention. Generally, the present invention may be utilized to transfer a patient 12 easily from one location to another. An example shown in the figures relates to transferring a patient 12 from a wheelchair 13 to a bed 14 (or vice versa). The functionality of the present invention should not be construed as limited in this respect, as the methods and systems described herein could be utilized for a wide range of other purposes. For example, the present invention could be utilized for functions unrelated to patients 12; such as to move an object such as a bulky or heavy object from one location to another.

As shown in FIG. 1, the platform 20 is first positioned and oriented such that the gap 39 of the walker frame 30 faces the patient 12 in his/her original position, such as in a wheelchair 13. The locking member 27 may then be engaged to prevent unintentional rotation of the platform 20 when the patient is stepping onto the platform 20. With the platform 20 locked and the gap 39 in the walker frame 30 facing the patient 12, the patient 12 may step up or be helped to step up onto the platform 20; using the walker frame 30 for additional stability.

With the patient 12 secured on the platform 20, the locking member 27 may be disengaged to allow for the platform 20 to be rotated with respect to the base 50. The platform 20 is then rotated with the patient 12 on the platform 20 such that the gap 39 faces the desired location to which the patient 12 is being moved, such as a bed 14 as shown in FIG. 2. The locking member 27 may then be engaged again to prevent further rotation of the platform 20 when the patient 12 is getting off the platform 20. With the locking member 27 engaged to prevent rotation of the platform 20 and the gap 39 facing the destination location for the patient 12, the patient 12 may step off or be helped to step off the platform 20 and onto the desired location, such as a bed 14.

Once the patient 12 has been safely moved, the platform 20 may be utilized for additional patients 12 in the same location or may be moved to another location to service additional patients 12 or for storage. To ease transport and storage, the walker frame 30 may be collapsed onto the platform 20 such as shown in FIG. 4.

To collapse the walker frame 30, the frontal supports 31, 35 are first disconnected from the platform 20 by removing the anchor pins 26 from the anchors 25 which connect the frontal supports 31, 35 to the platform 20. The rear supports 40, 43 may then be rotated inwardly and then rotated downwardly to rest on the platform 20 such as shown in FIG. 4. The rear supports 40, 43 may be secured against the platform 20 using the same anchors 25 and anchor pins 26.

With the walker frame 30 in a collapsed state, an individual may grasp the handles 48 to tilt the platform 20 upwardly and engage the wheels 58 with the ground. The present invention may then be transported in such a tilted orientation with the wheels 58 aiding its movement as shown in FIG. 5.

### F. Alternate Embodiment

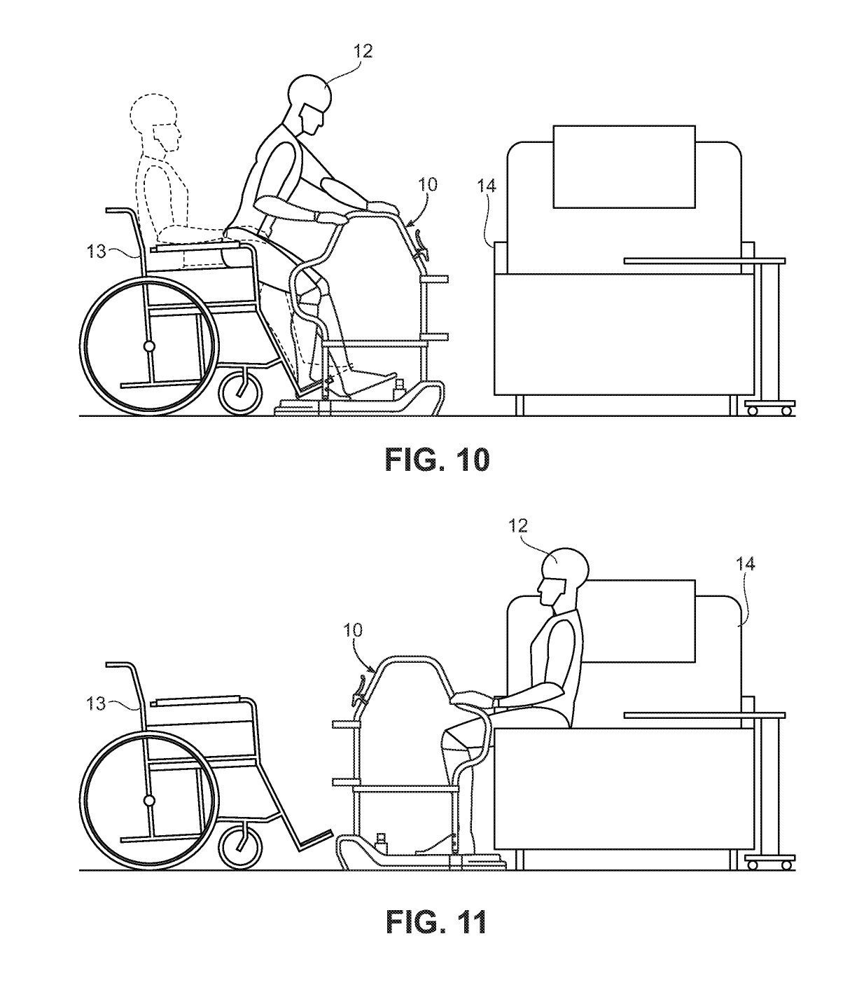

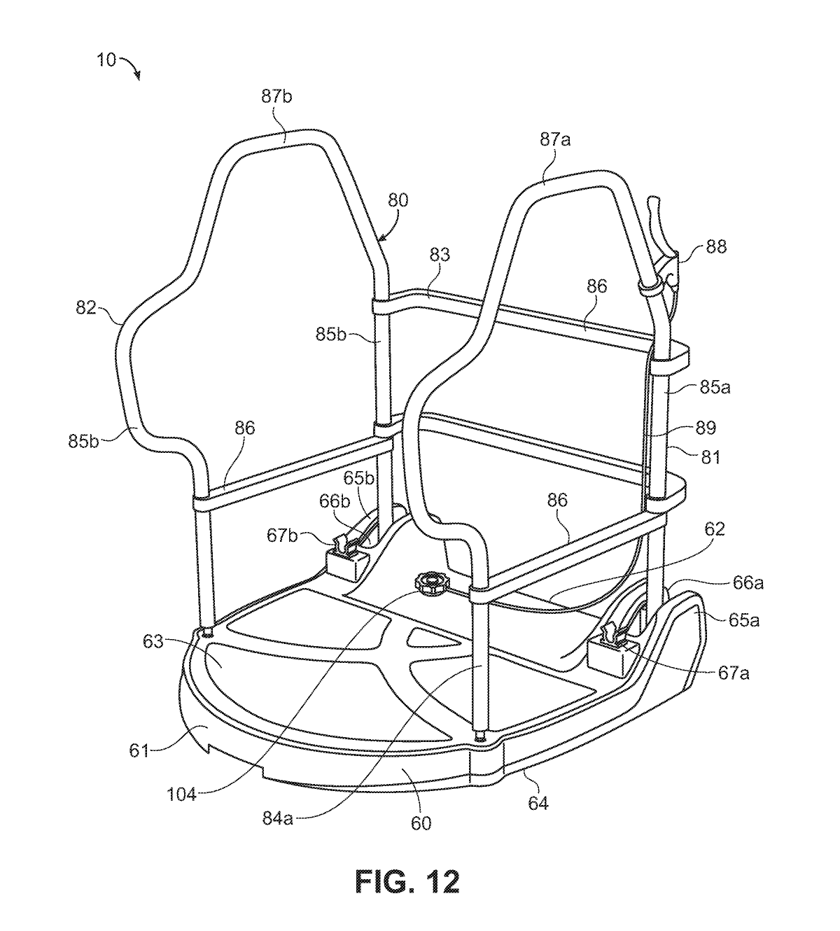

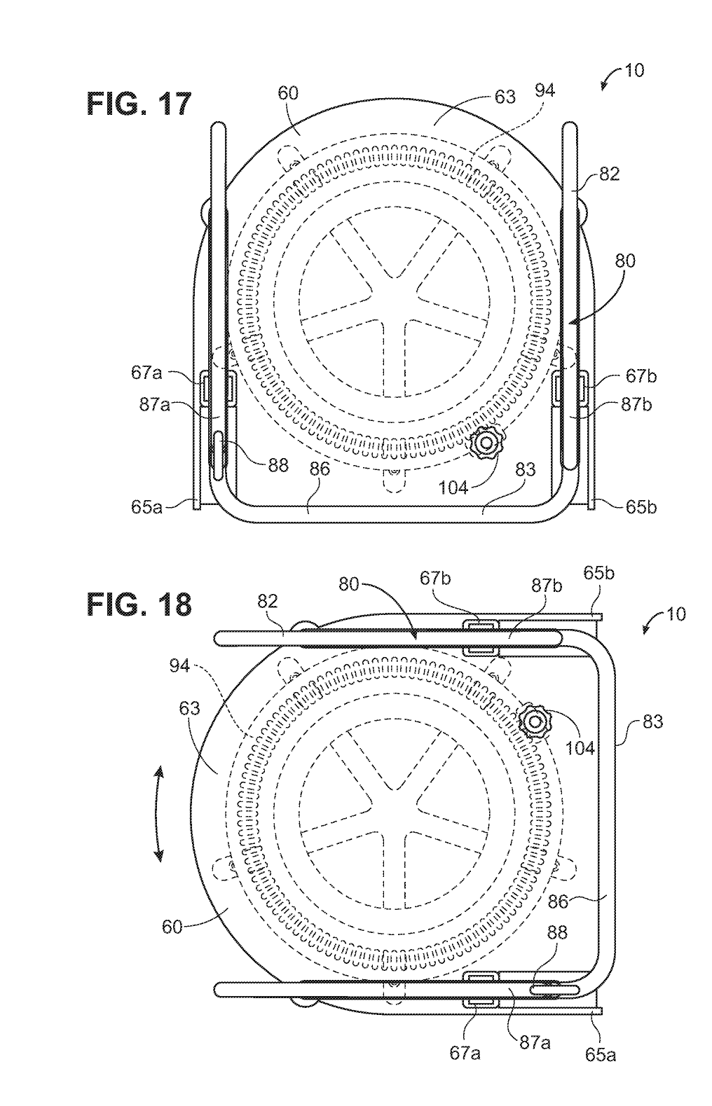

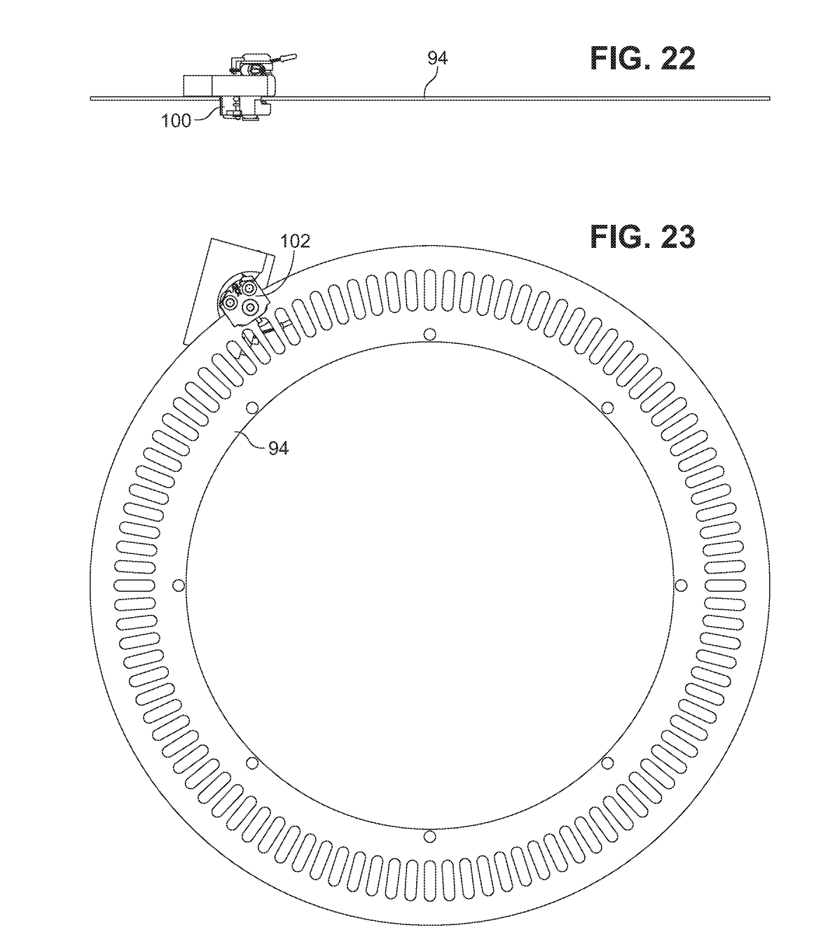

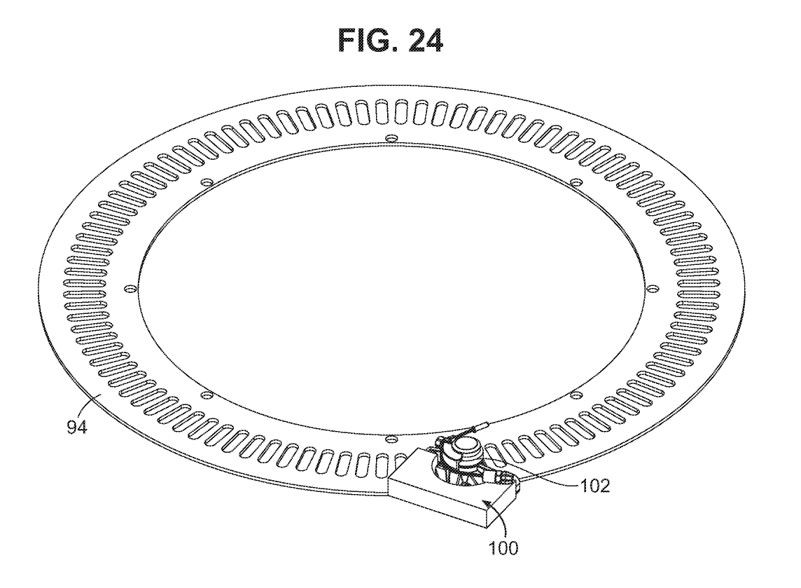

FIGS. 10-29 illustrate an exemplary alternate embodiment of a rotational platform system 10. As shown in FIG. 12, the exemplary alternate embodiment may comprise a platform 60 comprising an upper surface 63 and a lower surface 64. A walker frame 80 may be connected to the upper surface 63 of the platform 60, wherein the walker frame comprises a first frontal support 84a, a second frontal support 84b, a first rear support 85a, and a second rear support 85b, wherein the walker frame 80 is adapted to be at least partially collapsed onto the upper surface 63 of the platform 60. A base 90 may be adapted to contact a ground surface, wherein the platform 60 is selectively rotatable with respect to the base 90. A braking mechanism 100 may be provided for selectively inhibiting rotation of the platform 60 so as to lock the platform 60 into one of a plurality of rotational positions with respect to the base 90.

The walker frame 80 may be adjustable between a first position in which the walker frame 80 is expanded upright on the upper surface 63 of the platform 60 and a second position in which the walker frame 80 is collapsed onto the upper surface 63 of the platform 60. The walker frame 80 may comprise a pair of frontal supports 84; each of the frontal supports 84 being removably connected to the upper surface 63 of the platform 60. The walker frame 80 may comprise a pair of rear supports 85; each of the rear supports 85 being hingedly and rotatably connected to the platform 60.

The walker frame 80 may comprise a first side 81, a second side 82, and a rear portion 83, wherein the first side 81 and the second side 82 of the frame 80 are each adapted to rotate inwardly toward the rear portion 83. A first connector 70a and a second connector 70b may be hingedly connected to the base 90 with the frame 60 being connected to the first and second connectors 70a, 70b. The frame 80 may comprise a first rear support 85a and a second rear support 85b, wherein the first rear support 85a is rotatably connected to the first connector 70a and the second rear support 85b is rotatably connected to the second connector 70b. The first connector 70a may comprise a first wheel 73a and the second connector 70b may comprise a second wheel 73b.

The braking mechanism 100 may comprise a caliper brake 102; with the walker frame 80 including a brake handle 88. A brake connector 89 may interconnect the caliper brake 102 with the brake handle 88.

The first and second frontal supports 84a, 84b may each be removably connected to the upper surface 63 of the platform 60. The first and second rear supports 85a, 85b may be hingedly and rotatably connected to the platform 60, such as by the connectors 70a, 70b. The walker frame 80 may comprise a first side 81 comprised of the first frontal support 84a and first rear support 85a and a second side 82 comprised of the second frontal support 84b and the second rear support 85b. The first side 81 of the walker frame 80 may be adapted to swing about the first rear support 85a toward a rear end 62 of the platform 60. The second side 82 of the walker frame 80 may be adapted to swing about the second rear support 85b toward a rear end 62 of the platform 60.

As best shown in FIGS. 10-12, the exemplary alternate embodiment of a rotational transfer platform system 10 may comprise a platform 60 on which a patient 12 may stand when the present invention is in use. The platform 60 is adapted to be rotated with respect to a base 90 to maneuver a patient 12 between various locations; such as between a wheelchair 13 and a bed 14. The shape, size, and configuration of the platform 20 may vary in different embodiments and thus should not be construed as limited by the exemplary figures.

In the exemplary embodiment shown in FIG. 12, the platform 60 is illustrated as comprising a semi-ovular shape including a curved front end 61 and a straight rear end 62. It should be appreciated that a wide range of other shapes and configurations may be utilized, and the shape and configuration of the platform 60 should not be construed as limited to the semi-ovular shape shown in the figures. The front end 61 of the platform 60 is generally utilized by the patient 12 to get on or get off the platform 60. The rear end 62 of the platform 60 may include wheels 73 as described herein to aid in transporting the platform 60 when in its collapsed state.

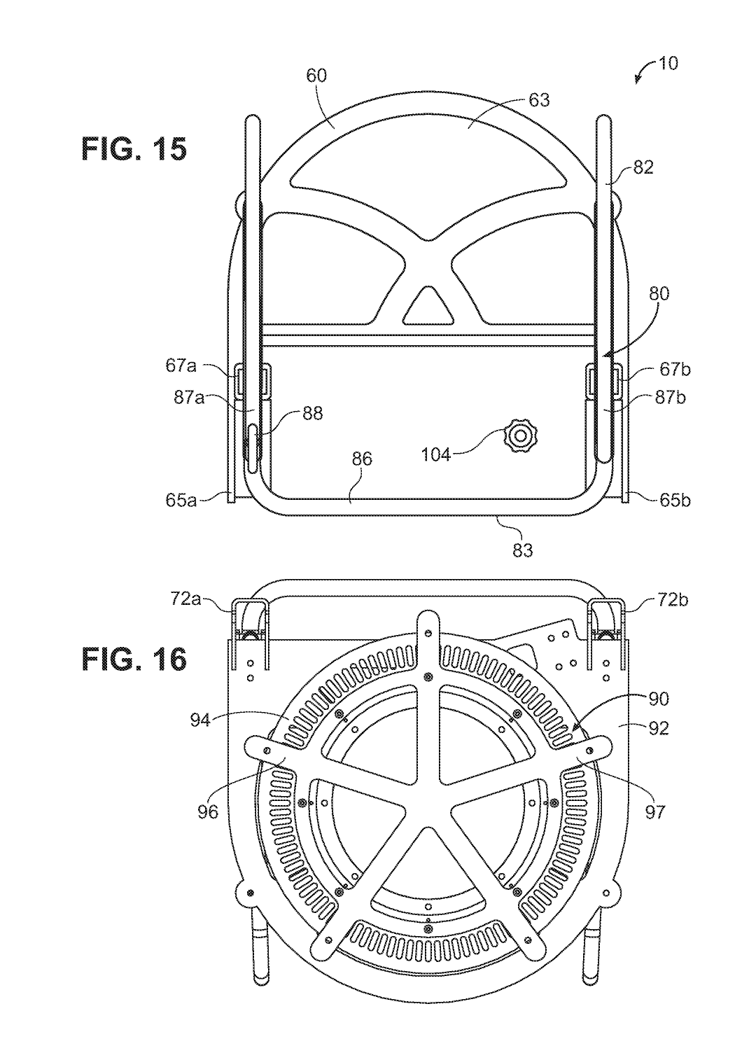

As shown in FIGS. 15-16, the platform 60 may comprise an upper surface 63 and a lower surface 64. A patient 12 will stand upon the upper surface 63 of the platform 60 when in use, such as shown in FIGS. 10-11. The upper surface 63 of the platform 60 may include a selectively collapsible and expandable walker frame 80 which may be grasped by the patient 12 when in use. The walker frame 80 in some embodiments may be completely removable from the platform 60. In other embodiments, the walker frame 80 may be partially removable from the platform 60 to allow the walker frame 80 to be collapsed onto the upper surface 63 of the platform 60 for transport.

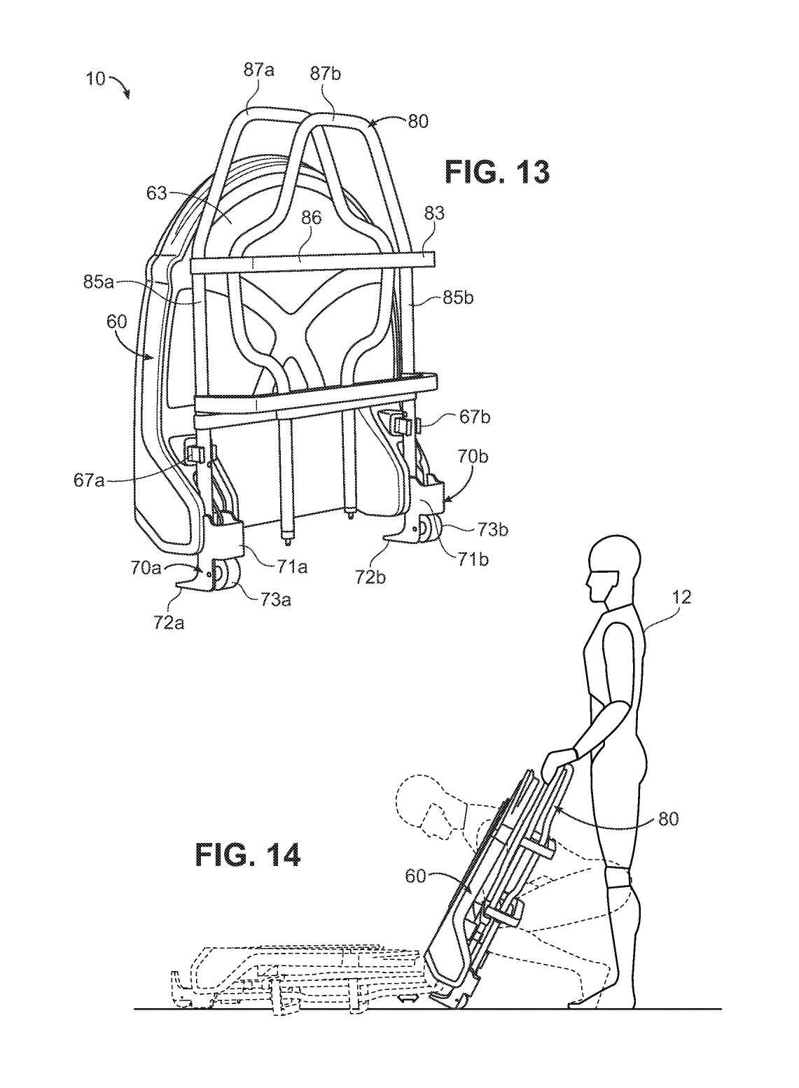

The lower surface 64 includes the base 90 which rests upon the ground surface when in use and not being transported or stored. The platform 60 may freely rotate absent application of a braking mechanism 100 as discussed herein. The lower surface 64 may also include wheels 73 which may be utilized to transport the platform 60 when in its collapsed state such as shown in FIGS. 13-14.

As shown in FIG. 12, the upper surface 63 of the platform 60 may comprise frame supports 65 which are adapted to support elements of the frame 80 such as the rear supports 85. The frame supports 65 are illustrated as being positioned at the rear end 62 of the platform 60, though they could be positioned at various other locations.

As shown in FIG. 12, the frame supports 65 may comprise a first frame support 65a for hingedly supporting the first rear support 85a and a second frame support 65b for hingedly supporting the second rear support 85b. The frame supports 65 may each comprise a receiver slot 66 in which the frame 80 may be hingedly secured. In the exemplary embodiment shown in FIG. 12, the first frame support 65a comprises a raised bracket having a first receiver slot 66a adapted to hingedly support and guide the first rear support 86a. The second frame support 65b comprises a raised bracket having a second receiver slot 66b adapted to hingedly support and guide the second rear support 86b.

As shown in FIG. 12, the upper surface 63 of the platform 60 may also comprise a pair of anchors 67 which are adapted to selectively and removably secure the frame 80 when in its collapsed state. In the exemplary embodiment shown in FIG. 13, a first anchor 67a is positioned in front of the first frame support 65a and a second anchor 67b is positioned in front of the second frame support 65b. Each of the anchors 67 are illustrated as comprising brackets which are fit so as to removably receive the frame 80 therein and be easily released by pulling on the frame 80 to release the frictional engagement between the anchors 67 and the frame 80.

As shown in FIGS. 12, 13, and 19A, the connectors 70 may be utilized to hingedly connect the frame 80 to the platform 60. The connectors 70 are illustrated as being positioned at the rear end 62 of the platform 60, though other positions could be utilized in different embodiments. The connectors 70 are adapted to receive and secure the frame 80; with the first connector 70a receiving and securing the first rear support 85a and the second connector 70b receiving and securing the second rear support 85b.

The connectors 70 are adapted to rotate with respect to the platform 60 such that the frame 80 may be collapsed or expanded. The frame 80, and more particularly the rear supports 85, may be adapted to rotate within the connectors 70 to allow the first and second sides 81, 82 of the frame 80 to be swung inwardly when collapsed as discussed below. As shown in the figures, various fasteners 74 may be utilized to interconnect the various components of the connectors 70.

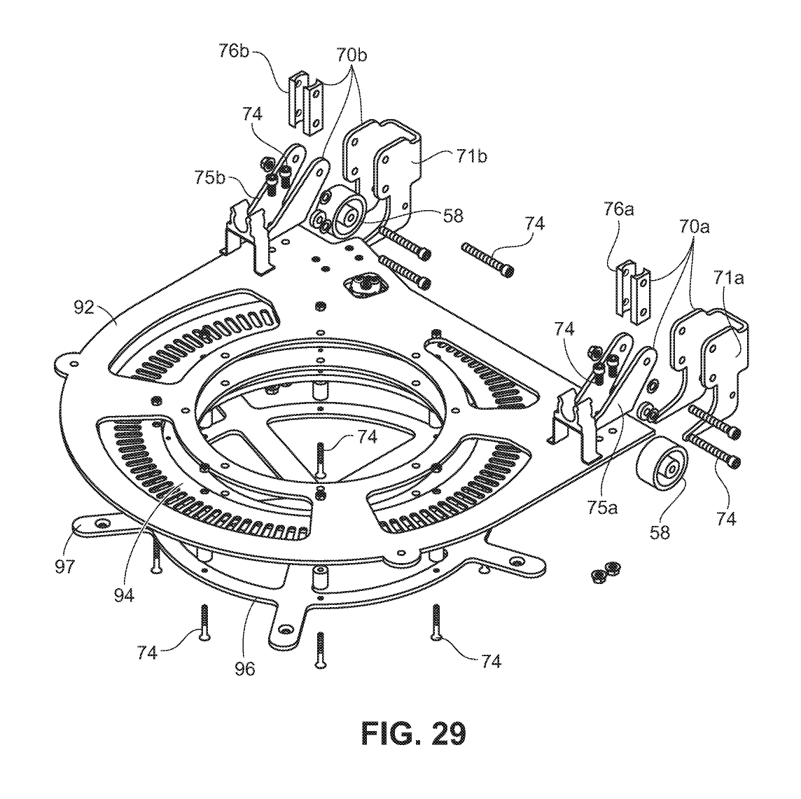

As shown in FIG. 29, the connectors 70 may each comprise a bracket 71 which is hingedly connected to a bracket linkage 75; the bracket linkage 75 being connected to the platform 60. In the exemplary embodiment shown in the figures, the first connector 70a comprises a first bracket 71a hingedly connected to the platform 60 by a first bracket linkage 75a and the second connector 70b comprises a second bracket 71b hingedly connected to the platform 60 by a second bracket linkage 75b. The bracket 71 is adapted to hingedly rotate with respect to the bracket linkage 75 and platform 60 as shown in the figures.

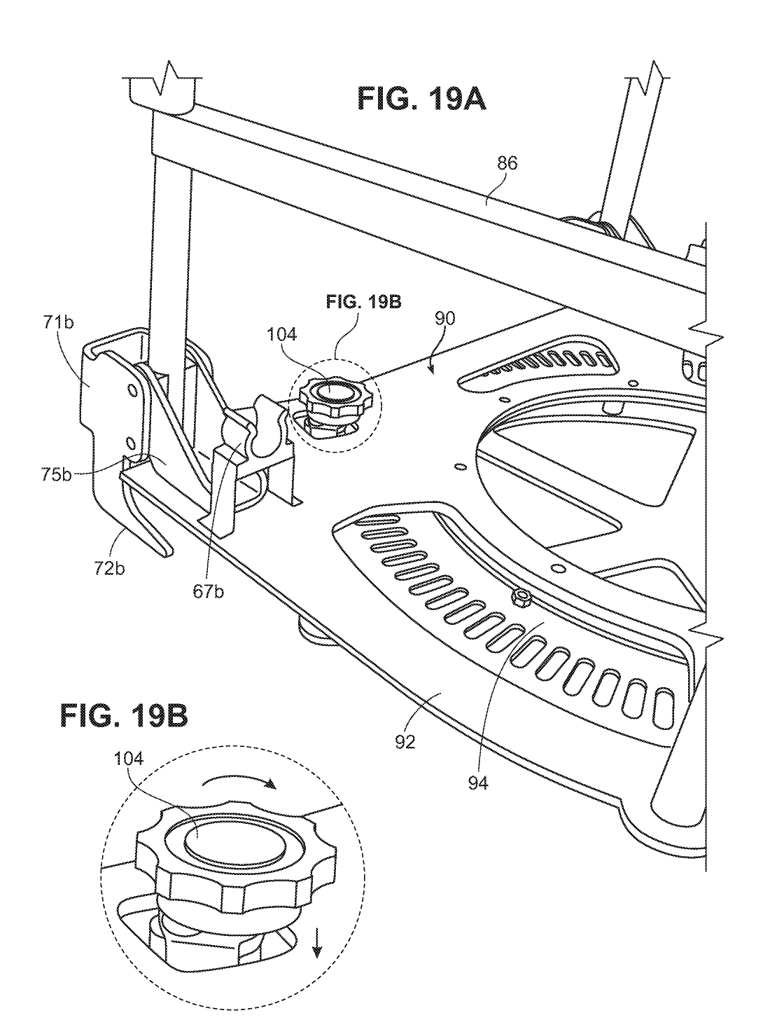

As shown in FIGS. 13-14, each of the connectors 70 may comprise a stand portion 72. The stand portion 72 may comprise an elongated portion which is adapted to serve as a stand for the platform 60 when the connectors 70 are in their upright position (e.g., when the platform 60 is configured for use rather than transport). When the connectors 70 are upright, the stand portion 72 extends parallel with respect to the platform 60 such as shown in FIG. 19A. When the connectors 70 are rotated to a resting position, the stand portion 72 extends perpendicular with respect to the platform 60 such as shown in FIG. 14. In the exemplary figures, the first connector 70a comprises a first stand portion 72a and the second connector 70b comprises a second stand portion 72b.

As shown in FIG. 13, the connectors 70 may comprise wheels 73 which are adapted to contact the ground when the connectors 70 are in their resting position so that the platform 60 may be easily transported. In the exemplary figures, the first connector 70a may include a first wheel 73a and the second connector 70b may include a second wheel 73b.

As shown in FIG. 29, the connectors 70 may comprise spacers 76 which are positioned between the frame 80 and the brackets 71 to secure the frame 80 within the brackets 71. The spacers 76 may be configured such that the frame 80 may rotate within the brackets 71. In the exemplary embodiment shown in the figures, the first connector 70a may comprise first spacers 76a and the second connector 70b may comprise second spacers 76b.

An exemplary walker frame 80 is best shown in FIG. 12. It should be appreciated that the exemplary embodiment shown in the figures is merely exemplary, and the walker frame 80 may comprise different configurations to suit different needs of different patients 12. In the exemplary configuration shown in the figures, the walker frame 80 may comprise a first side 81, a second side 82, and a rear portion 83. The frontal end of the frame 80 is open to allow a patient 12 to easily access the platform 60.

As shown in FIG. 12, the frame 80 may comprise a pair of frontal supports 84 and a pair of rear supports 85. Each of the frontal and rear supports 84, 85 may comprise elongated rods or the like such as shown in the figures which together form the frame 80.

In the exemplary embodiment shown in FIG. 12, the frame 80 comprises a first frontal support 84a and second frontal support 84b which are each removably connected to the upper surface 63 of the platform 60. The upper surface 63 of the platform 60 may include openings or other receivers adapted to removably receive and engage with the frontal supports 84.

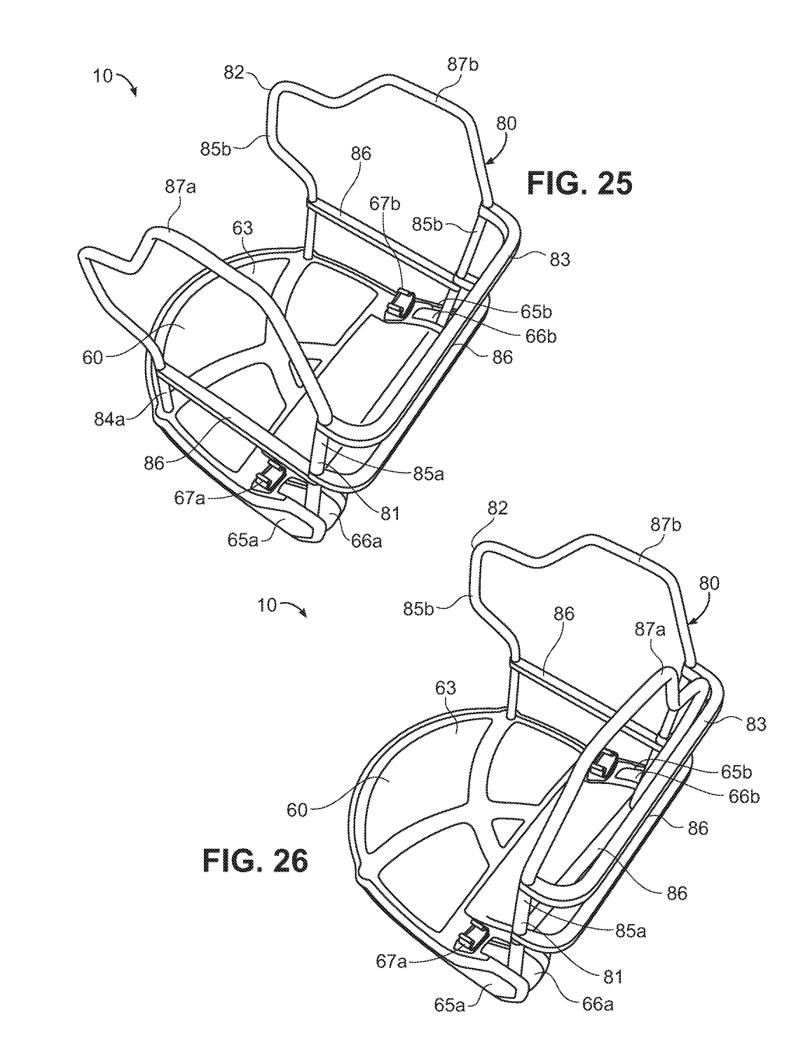

As shown in FIGS. 25-28, the frame 80 may comprise a first rear support 85a and a second rear support 85b which are rotatably and hingedly connected to the platform 60, such as by the frame supports 65. The rear supports 85 may be rotatably connected within the receiver slots 66 of the frame supports 65 of the platform 60; with the receiver slots 66 acting as guides to guide the hinged rotation of the rear supports 85 as discussed herein and shown in the exemplary figures.

As shown in the figures, various cross supports 86 may interconnect the front and rear supports 84, 85 of the frame 80 to form the unitary frame 80. The first side 81 of the frame 80 may comprise the first frontal support 84a and first rear support 85a interconnected by a cross support 86. The second side 82 of the frame 80 may comprise the second frontal support 84b and second rear support 85b interconnected by a cross support 86. Both the first and second sides 81, 82 of the frame 80 may be swung (rotated) inwardly toward the rear portion 83 when collapsing the frame 80 as discussed herein.

As best shown in FIG. 25, the frame 80 may include handle portions 87 adapted to be grasped by a patient 12 when the present invention is in use. As shown, the first side 81 of the frame 80 may comprise a first handle portion 87a and the second side 82 of the frame 80 may comprise a second handle portion 87b.

A brake handle 88 may be positioned on the frame 80, such as at or near the handle portions 87, and interconnected with the braking mechanism 100 by a brake connector 89 so that the braking mechanism 100 may be activated or released by the brake handle 88. Although the figures illustrate the brake handle 88 being connected to the first handle portion 87a, it should be appreciated that the brake handle 88 in some embodiments could be connected to the second handle portion 87b instead. In other embodiments, the brake handle 88 may be positioned at various other locations on the frame 80.

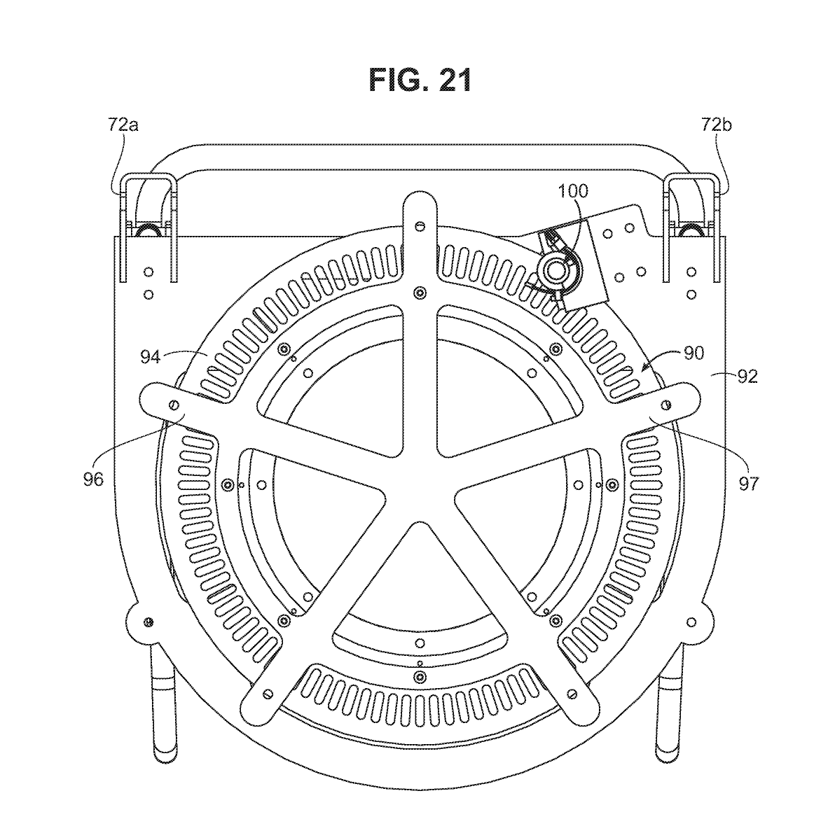

As best shown in FIGS. 21 and 29, a base 90 may be provided which allows the platform 80 to rotate with respect to the ground surface underneath the platform 80. The base 90 may comprise an upper member 92, a base member 96, and a rotational member 94 positioned between the upper member 92 and the base member 96. The upper member 92 (and the platform 60 which is secured to the upper member 92) may rotate with respect to the rotational member 94 and base member 96 when the braking mechanism 100 is not engaged.

As shown in FIG. 29, various fasteners 74 may be utilized to interconnect the components of the base 90 such as the upper member 92, rotational member 94, and/or base member 96. The base member 96 may comprise base supports 97 illustrated as comprising elongated extensions which rest upon the ground and around which the platform 60 may rotate.

As best shown in FIGS. 21-24, a braking mechanism 100 may be utilized to selectively restrict rotation of the platform 60 with respect to the base 90. As shown in FIGS. 21-24 and 29, the braking mechanism 100 may be connected so as to selectively frictionally engage with the rotational member 94 of the base 90. When so frictionally engaged, the platform 60 will be locked from rotating with respect to the base 90. When not engaged, the rotational member 94 will freely rotate within the braking mechanism 100.

Various types of braking mechanisms 100 may be utilized in different embodiments. In the exemplary embodiment shown in the figures, the braking mechanism 100 is illustrated as comprising a caliper brake 102 similar to what is used on standard bicycles. A brake connector 89 such as a wire interconnects the caliper brake 102 with the brake handle 88 such that engagement of the brake handle 88 will pull on the brake connector 89 and cause the caliper brake 102 to close and engage with the base 90 to prevent rotation of the platform 60.

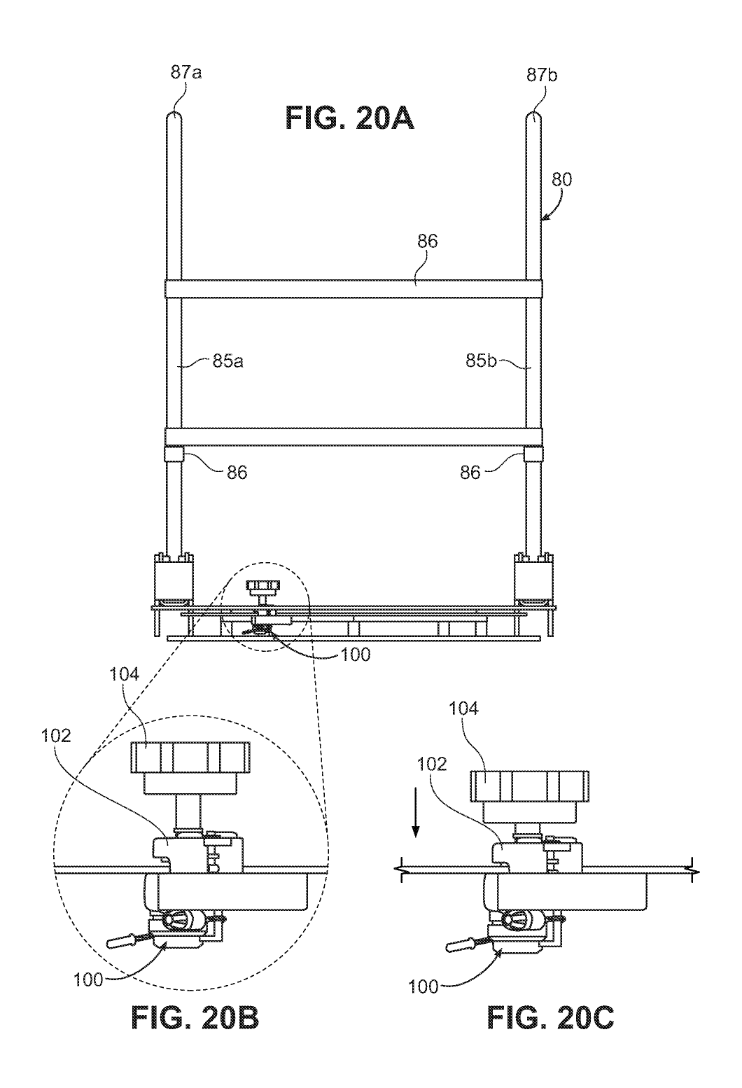

In the exemplary embodiment as shown in FIGS. 20A-20C, the caliper brake 102 may include a tension knob 104 which extends upwardly from the platform 60. The tension knob 104 may be rotated in a first direction to tighten the caliper brake 102 and rotated in a second direction to loosen the caliper brake 102. In this manner, the responsiveness of the braking mechanism 100 to action of the brake handle 88 may be adjusted (i.e., less or more pressure on the brake handle 88 to engage the braking mechanism 100).

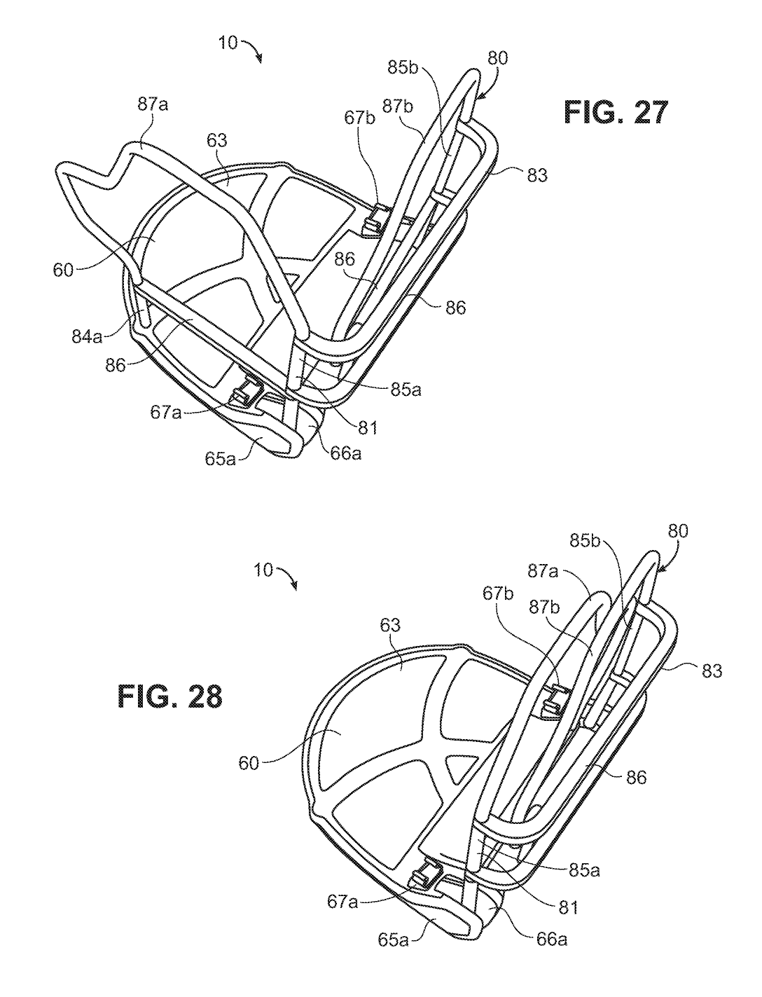

In use, the frame 80 may be adjusted between an expanded position for use and a collapsed position for transport. The expanded position is best shown in FIG. 12. The collapsed position is shown in FIG. 13. The process of collapsing the frame 80 is shown in FIGS. 25-28. As shown in FIG. 26, the first side 81 of the frame 80 is first swung or rotated toward the rear portion 83 of the walker frame 80. More specifically, the first frontal support 84a is released from the platform 60 and rotated about the first rear support 85a to rest against the rear portion 83 of the frame 80 such as shown in FIG. 26. Alternatively, the second frontal support 84b could first be released from the platform 60 and rotated about the second rear support 85b to rest against the rear portion 83 of the frame 80 such as shown in FIG. 27.

The remaining frontal support 85a, 85b may then be rotated so that both of the frontal supports 85a, 85b rest against the rear portion 83 such as shown in FIG. 28. The frame 80 may then be collapsed fully onto the platform 60 such as shown in FIG. 13. The frame 80 may be secured against the platform 60 by the anchors 67 such as shown in FIG. 13. An individual may grasp the frame 80 and tilt the platform 60 so that the wheels 73 engage with the ground for movement such as shown in FIG. 14. The reverse steps may be taken to expand the frame 80; with the frame 80 being released from the anchors 67 and then pulled upwardly and outwardly to lock into place for use.

With the walker frame 80 in its expanded state, a patient 12 may utilize the present invention. Generally, the present invention may be utilized to transfer a patient 12 easily from one location to another. An example shown in the figures relates to transferring a patient 12 from a wheelchair 13 to a bed 14 (or vice versa). The functionality of the present invention should not be construed as limited in this respect, as the methods and systems described herein could be utilized for a wide range of other purposes. For example, the present invention could be utilized for functions unrelated to patients 12; such as to move an object such as a bulky or heavy object from one location to another.

As shown in FIG. 10, the platform 60 is first positioned and oriented such that the front end 61 of the walker frame 80 faces the patient 12 in his/her original position, such as in a wheelchair 13. The braking mechanism 100 may then be engaged to prevent unintentional rotation of the platform 60 when the patient is stepping onto the platform 60. With the platform 60 locked, the patient 12 may step up or be helped to step up onto the platform 60; using the walker frame 80 for additional stability.

With the patient 12 secured on the platform 60, the braking mechanism 100 may be disengaged to allow for the platform 60 to be rotated with respect to the base 90. The platform 60 is then rotated with the patient 12 on the platform 60 such that the front end 61 faces the desired location to which the patient 12 is being moved, such as a bed 14 as shown in FIG. 11. The braking mechanism 100 may then be engaged again to prevent further rotation of the platform 60 when the patient 12 is getting off the platform 60. With the braking mechanism 100 engaged to prevent rotation of the platform 60 and the front end 61 facing the destination location for the patient 12, the patient 12 may step off or be helped to step off the platform 60 and onto the desired location, such as a bed 14.

Once the patient 12 has been safely moved, the platform 60 may be utilized for additional patients 12 in the same location or may be moved to another location to service additional patients 12 or for storage. To ease transport and storage, the walker frame 80 may be collapsed onto the platform 60 such as shown in FIG. 13.

Unless otherwise defined, all technical and scientific terms used herein have the same meaning as commonly understood by one of ordinary skill in the art to which this invention belongs. Although methods and materials similar to or equivalent to those described herein can be used in the practice or testing of the rotational transfer platform system, suitable methods and materials are described above. All publications, patent applications, patents, and other references mentioned herein are incorporated by reference in their entirety to the extent allowed by applicable law and regulations. The rotational transfer platform system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A rotational transfer platform system, comprising:
a platform comprising an upper surface and a lower surface;
a walker frame connected to the upper surface of the platform, wherein the walker frame is adapted to be at least partially collapsed onto the upper surface of the platform;
a base adapted to contact a ground surface, wherein the platform is selectively rotatable with respect to the base; and
a braking mechanism for selectively inhibiting rotation of the platform so as to lock the platform into one of a plurality of rotational positions with respect to the base.

2. The rotational transfer platform system of claim 1, wherein the walker frame is adjustable between a first position in which the walker frame is expanded upright on the upper surface of the platform and a second position in which the walker frame is collapsed onto the upper surface of the platform.

3. The rotational transfer platform system of claim 1, wherein the walker frame comprises a pair of frontal supports, each of the frontal supports being removably connected to the upper surface of the platform.

4. The rotational transfer platform system of claim 3, wherein the walker frame comprises a pair of rear supports, each of the rear supports being hingedly and rotatably connected to the platform.

5. The rotational transfer platform system of claim 1, wherein the walker frame comprises a first side, a second side, and a rear portion, wherein the first side and the second side of the frame are each adapted to rotate inwardly toward the rear portion.

6. The rotational transfer platform system of claim 1, comprising a first connector and a second connector hingedly connected to the base, wherein the frame is connected to the first connector and the second connector.

7. The rotational transfer platform system of claim 6, wherein the walker frame comprises a first rear support and a second rear support, wherein the first rear support is rotatably connected to the first connector and the second rear support is rotatably connected to the second connector.

8. The rotational transfer platform system of claim 6, wherein the first connector comprises a first wheel and wherein the second connector comprises a second wheel.

9. The rotational transfer platform system of claim 1, wherein the braking mechanism comprises a caliper brake.

10. The rotational transfer platform system of claim 9, wherein the walker frame comprises a brake handle.

11. The rotational transfer platform system of claim 10, comprising a brake connector connected between the brake handle and the caliper brake.

12. A rotational transfer platform system, comprising:
a platform comprising an upper surface and a lower surface;
a walker frame connected to the upper surface of the platform, wherein the walker frame comprises a first frontal support, a second frontal support, a first rear support, and a second rear support, wherein the walker frame is adapted to be at least partially collapsed onto the upper surface of the platform;
a base adapted to contact a ground surface, wherein the platform is selectively rotatable with respect to the base; and
a braking mechanism for selectively inhibiting rotation of the platform so as to lock the platform into one of a plurality of rotational positions with respect to the base.

13. The rotational transfer platform system of claim 12, wherein the first and second frontal supports are each removably connected to the upper surface of the platform.

14. The rotational transfer platform system of claim 13, wherein the first and second rear supports are hingedly and rotatably connected to the platform.

15. The rotational transfer platform system of claim 14, wherein the walker frame comprises a first side comprised of the first frontal support and the first rear support and a second side comprised of the second frontal support and the second rear support.

16. The rotational transfer platform system of claim 15, wherein the first side of the walker frame is adapted to swing about the first rear support toward a rear end of the platform.

17. The rotational transfer platform system of claim 16, wherein the second side of the walker frame is adapted to swing about the second rear support toward the rear end of the platform.

18. The rotational transfer platform system of claim 12, wherein the braking mechanism comprises a caliper brake.

19. The rotational transfer platform system of claim 18, wherein the walker frame comprises a brake handle.

20. The rotational transfer platform system of claim 19, comprising a brake connector connected between the brake handle and the caliper brake.
